(19) United States
(12) Patent Application Publication
(10) Pub. No.: US 2010/0172045 A1
(43) Pub. Date: Jul. 8, 2010

(54) CALIBRATION OF AN AUTOMATED DATA STORAGE LIBRARY WITH A CARTRIDGE-LIKE ELEMENT

(76) Inventors: BRIAN GERARD GOODMAN, Tucson, AZ (US); Ronald Faye Hill, JR., Tucson, AZ (US); Kenny Nian Gan Qiu, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 12/349,711

(22) Filed: Jan. 7, 2009

(51) Int. Cl. G11B 27/036

(52) U.S. Cl. 360/31; G9B/27.013

(57) ABSTRACT

Calibration of an automated data storage library having a plurality of storage slots configured to store at least one data storage cartridge. An element is placed in one of the plurality of storage slots having a known location, the element having similar external dimensions as a data storage cartridge having a fiducial mark thereon. The fiducial mark is sensed, and the position of the fiducial mark is calibrated with respect to the known location of the storage slot. The element comprises an exterior shell having similar external dimensions as a data storage cartridge; and the fiducial mark located on the exterior shell comprises at least one contrasting edge defining a specific calibration location on the element.

### DOCUMENTS INCORPORATED BY REFERENCE

Commonly assigned U.S. Patent Application Publication No. 2005/0261850, filed May 24, 2004 is incorporated for its showing of a calibration system for an automated data storage library; and commonly assigned U.S. patent application Ser. No. 12/200,689, filed Aug. 28, 2008, is incorporated for its showing of an automated data storage library having both multi-cartridge deep slot cells and single cartridge storage slots.

### FIELD OF THE INVENTION

This invention relates to automated data storage libraries configured to store data storage cartridges in a plurality of storage slots, and, more particularly, to calibration of at least one location in the library.

### BACKGROUND OF THE INVENTION

Automated data storage libraries are known for providing cost effective storage and retrieval of large quantities of data, typically from data storage cartridges stored in storage slots of the library. The data storage cartridges are typically extracted from the storage slots, placed in the storage slots, and transported within the library by one or more accessors. In order to operate at the highest efficiency, the controller(s) operating the accessor(s) must know the precise location of each cartridge that is being accessed to be extracted and the precise location of the storage slot at which a cartridge is to be placed.

Mechanical tolerances typically exist within a library such that the precise positions of the storage slots and the cartridges they contain may be different from the expected positions. Calibration techniques may employ fiducial marks (also called calibration targets) permanently provided at points within the library to ascertain the difference between where the fiducial is expected to be located and where it is actually located. For example, a fiducial may be located at a corner within a library frame or a bank of storage slots in the frame. This difference is then employed to adjust the expected location of one or more points within the frame or that bank of storage slots. Performing this calibration allows greater tolerances in the design and manufacture of the library and its components.

It may be desirable to provide calibration at additional points within the library, exemplified by the advent of libraries having multi-cartridge deep slot cells, to insure that cartridges are correctly accessed.

### SUMMARY OF THE INVENTION

Calibration of an automated data storage library having a plurality of storage slots configured to store at least one data storage cartridge, in one embodiment, comprises placing a cartridge-like element having similar external dimensions as a data storage cartridge in one of the plurality of storage slots having a known location, the cartridge having a fiducial mark thereon; sensing the fiducial mark; and calibrating the position of the fiducial mark with respect to the known location of the storage slot.

In one embodiment, the element comprises an exterior shell having similar external dimensions as a data storage cartridge; and a fiducial mark located on the exterior shell comprising at least one contrasting edge defining a specific calibration location on the element.

In a further embodiment, the fiducial mark comprises an energy emitting, energy absorbing and/or energy reflecting mark contrasting with the remainder of the fiducial mark to form the contrasting edge(s).

In another embodiment, the step of sensing the fiducial mark comprises emitting energy towards the element and reading back energy from the fiducial mark.

In a further embodiment, the fiducial mark comprises at least an edge of the element, and the step of sensing the fiducial mark comprises reading the presence of the edge from reflected energy.

In another embodiment, the fiducial mark comprises an energy emitting material, and the step of sensing the fiducial mark comprises reading the energy from the fiducial mark.

In another embodiment, where the automated data storage library comprises at least one accessor configured to selectively extract, place and transport the data storage cartridges with respect to the storage slots; and the placing step and the sensing step are conducted by the accessor(s).

In a further embodiment, the plurality of storage slots comprise both single cartridge storage slots and multi-cartridge deep slot cells arranged in tiers from front to rear; and the step of placing the cartridge comprises placing the cartridge in one of the single cartridge storage slots and the frontmost tier of one of the multi-cartridge deep slot cells.

In another embodiment, the sensor comprises a camera.

In still another embodiment, the sensor comprises a Hall effect detector.

For a fuller understanding of the present invention, reference should be made to the following detailed description taken in conjunction with the accompanying drawings.

### BRIEF DESCRIPTION OF THE DRAWINGS

FIG. 1 is an isometric view of an example of an automated data storage library in accordance with an embodiment of the present invention;

FIG. 2 is an isometric view of a frame of the automated data storage library of FIG. 1, with the view specifically depicting an exemplary basic configuration of the internal components of a library;

FIG. 3 is a block diagram of the automated data storage library of FIGS. 1 and 2, with the diagram specifically depicting a library that employs a distributed system of modules with a plurality of processor nodes;

FIG. 4 is a block diagram depicting an exemplary controller configuration;

FIGS. 5A and 5B are isometric views of the front and rear of a data storage drive of the automated data storage library of FIGS. 1, 2 and 3;

FIG. 6 is an isometric view of an example of an element, such as a cartridge, which may be placed in a storage slot of the automated data storage library of FIGS. 1, 2 and 3, in accordance with an embodiment of the present invention;

FIGS. 7A and 7B illustrate one example of a multi-cartridge deep slot cell of the automated data storage library of FIGS. 1, 2 and 3;

FIG. 8 illustrates one example of single cartridge storage slots of the automated data storage library of FIGS. 1, 2 and 3;

FIG. 9 is an isometric view of a gripper assembly of an accessor of the automated data storage library of FIGS. 1, 2 and 3;

FIGS. 10a, 10b, 10c and 10d illustrate embodiments of fiducial marks employed with the element of FIG. 6; and

FIG. 11 illustrates one embodiment of a method for calibrating storage slots of the automated data storage library of FIGS. 1, 2 and 3 in accordance with one aspect of the invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

The invention will be described as embodied in an automated magnetic tape library storage system for use in a data processing environment. Although the invention shown uses magnetic tape cartridges, one skilled in the art will recognize the invention equally applies to optical disk cartridges or other removable storage media and the use of either different types of cartridges or cartridges of the same type having different characteristics. Furthermore the description of an automated magnetic tape storage system is not meant to limit the invention to magnetic tape data processing applications as the invention herein can be applied to any media storage and cartridge handling systems in general.

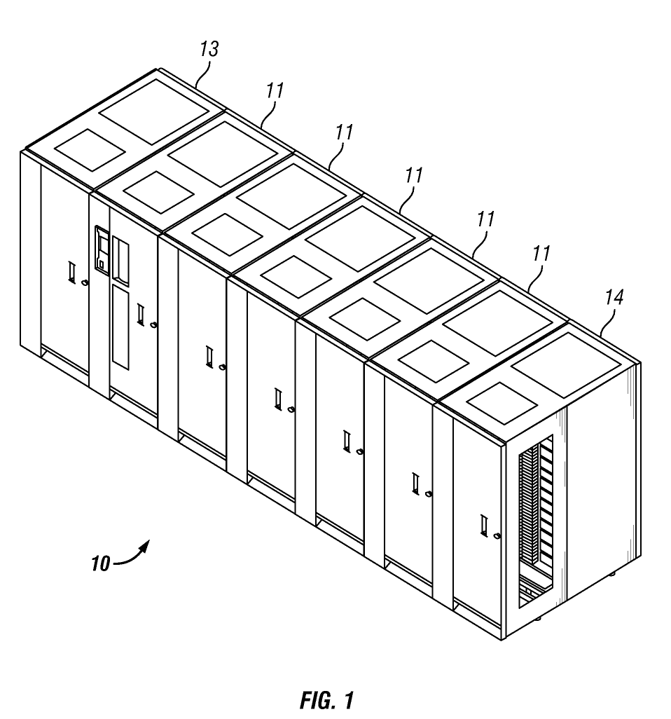

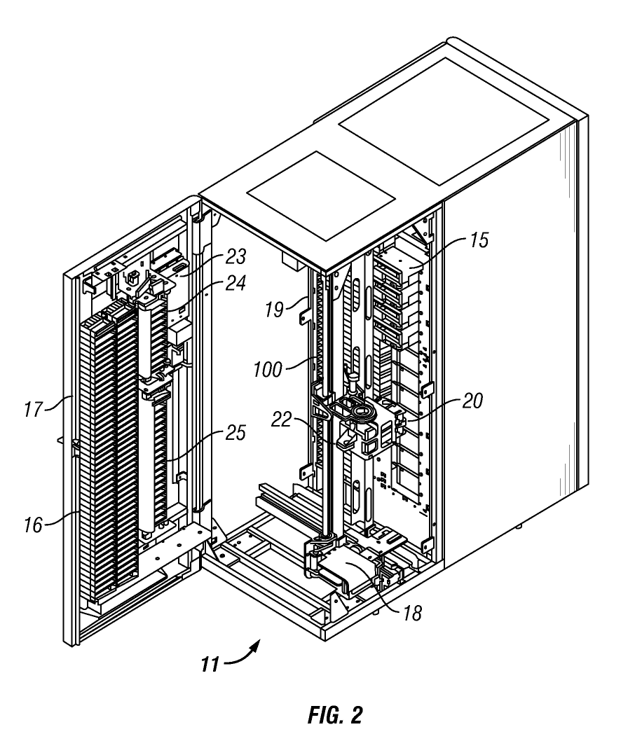

FIGS. 1 and 2 illustrate an automated data storage library 10 which stores and retrieves data storage cartridges containing data storage media (not shown) at multi-cartridge deep slot cells 100 and single cartridge storage slots 16. It is noted that references to “data storage media” herein refer to the recording media of data storage cartridges, and for purposes herein the two terms may also be used synonymously. The library of FIG. 1 comprises a left hand service bay 13, one or more storage frames 11, and right hand service bay 14. As will be discussed, a frame may comprise an expansion component of the library. Frames may be added or removed to expand or reduce the size and/or functionality of the library. Frames may comprise additional storage slots, deep slot cells, drives, import/export stations, accessors, operator panels, etc.

FIG. 2 shows an example of a storage frame 11, which is the base frame of the library 10 and is contemplated to be the minimum configuration of the library. In this minimum configuration, there is only a single accessor (i.e., there are no redundant accessors) and there is no service bay. The library 10 is arranged for accessing data storage media in response to commands from at least one external host system (not shown), and comprises a plurality of storage slots 16 on front wall 17 and a plurality of multi-cartridge deep slot cells 100 on rear wall 19, both for storing data storage cartridges that contain data storage media. The storage slots 16 are configured to store a single data storage cartridge, and the multi-cartridge deep slot cells 100 are configured to store a plurality of data storage cartridges arranged in sequential order of tiers from front to rear. The library also comprises at least one data storage drive 15 for reading and/or writing data with respect to the data storage media; and a first accessor 18 for transporting the data storage cartridges between the plurality of storage slots 16, the multi-cartridge deep slot cells 100, and the data storage drive(s) 15. The data storage drives 15 may be optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage cartridges to be added to the library inventory and/or removed from the library without disrupting library operation. Herein, adding data storage cartridges to the library may also be called “inserting” or “importing” data storage cartridges. Herein, removing data storage cartridges from the library may also be called “ejecting” or “exporting” data storage cartridges. Also herein, slots of the multi-cartridge deep slot cells 100, the single cartridge storage slots 16, the cartridge slot of drive(s) 15, and the slots of I/O station 24, 25 may all be referred to as storage slots. Thus, any location at which a data storage cartridge may reside within the library 10 may be referred to as a storage slot. The library 10 may comprise one or more storage frames 11, each having storage slots 16 and/or multi-cartridge deep slot cells 100 accessible by first accessor 18.

As described above, the storage frames 11 may be configured with different components depending upon the intended function. One configuration of storage frame 11 may comprise storage slots 16 and/or multi-cartridge deep slot cells 100, data storage drive(s) 15, and other optional components to store and retrieve data from the data storage cartridges, and another storage frame 11 may comprise storage slots 16 and/or multi-cartridge deep slot cells 100 and no other components.

For a fuller understanding of an automated data storage library having both single cartridge storage slots 16 and multi-cartridge deep slot cells 100, refer to U.S. patent application Ser. No. 12/200,689, filed Aug. 28, 2008, which is incorporated herein for reference.

The first accessor 18 comprises a gripper assembly 20 for gripping one or more data storage cartridges. The gripper assembly may include one or more sensors 22, mounted on the gripper 20, to “read” identifying information about the data storage cartridge and to locate fiducial marks, as will be discussed.

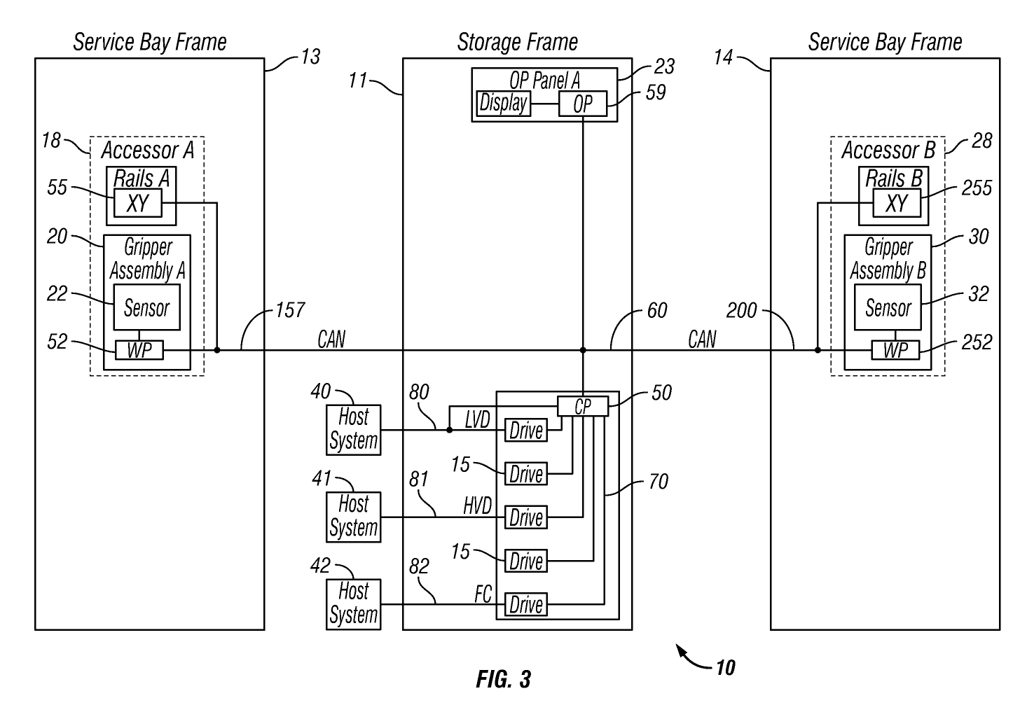

FIG. 3 illustrates an embodiment of an automated data storage library 10 of FIGS. 1 and 2, which employs a controller arranged as a distributed system of modules with a plurality of processor nodes. An example of an automated data storage library which may implement the distributed system depicted in the block diagram of FIG. 3, and which may implement the present invention, is the IBM TS3500 Tape Library.

While the automated data storage library 10 is illustrated as employing a distributed control system, the present invention may be implemented in automated data storage libraries regardless of control configuration, such as, but not limited to, an automated data storage library having one or more library controllers that are not distributed.

The library of FIG. 3 comprises one or more storage frames 11, a left hand service bay 13 and a right hand service bay 14. The left hand service bay 13 is shown with a first accessor 18. As discussed above, the first accessor 18 comprises a gripper assembly 20 and may include one or more sensors 22 to “read” identifying information about the data storage cartridges and to locate and calibrate fiducial marks. The right hand service bay 14 is shown with a second accessor 28. The second accessor 28 comprises a gripper assembly 30 and may include one or more sensors 32 to “read” identifying information about the data storage cartridges and to locate fiducial marks. In the event of a failure or other unavailability of the first accessor 18, or its gripper 20, etc., the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip, or to deliver and release the data storage cartridge at the storage slots 16 and multi-cartridge deep slot cells 100, or input/output stations 24, 25, and to mount and demount the data storage cartridge at the data storage drives 15.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage cartridges and move the cartridges, for example, between the storage slots 16 and the data storage drives 15. The commands are typically logical commands identifying the cartridges or cartridge media and/or logical locations for accessing the media. The terms “commands” and “work requests” are used interchangeably herein to refer to such communications from the host system 40, 41 or 42 to the library 10 as are intended to result in accessing particular data storage media within the library 10.

The exemplary library is controlled by a library controller, which in one embodiment comprises a distributed control system receiving the logical commands from hosts, determining the required actions, and converting the actions to physical movements of and actions by first accessor 18 and/or second accessor 28.

In the exemplary library, the distributed control system comprises a plurality of processor nodes, each having one or more computer processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, host connections 80 and 81 are SCSI busses. Bus 82 comprises an example of a Fibre Channel bus which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage slots 16, multi-cartridge storage cells 100, data storage drives 15, and networks 60.

Further, as described above, the automated data storage library 10 may comprise a plurality of accessors. A second accessor 28, for example, is shown in a right hand service bay 14 of FIG. 3. The second accessor 28 may comprise a gripper 30 for accessing the data storage cartridges, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13. Alternatively, one or more of the processor nodes (XY 55, WP 52, CP 50, OP 59, XY 255, and WP 252) may comprise dual networks (not shown) to allow independent redundant communication between the processor nodes and/or the accessors 18, 28.

In FIG. 3 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

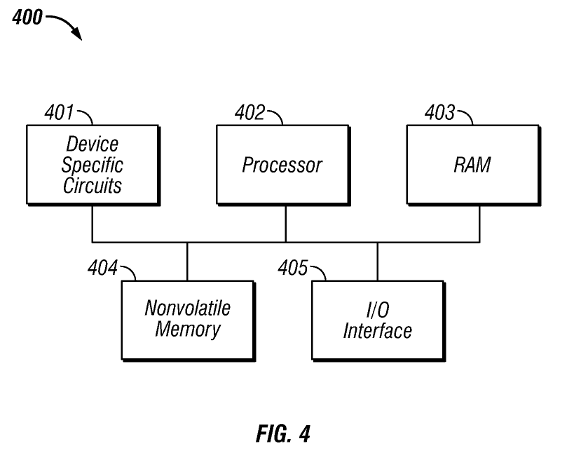

An automated data storage library 10 typically comprises one or more controllers to direct the operation of the automated data storage library. Host computers and data storage drives typically comprise similar controllers. A library controller may take many different forms and may comprise, for example but not limited to, an embedded system, a distributed control system, a personal computer, or a workstation. Essentially, the term “library controller” as used herein is intended in its broadest sense as a device that contains at least one computer processor, as such term is defined herein. FIG. 4 shows a typical controller 400 with a processor 402, RAM (Random Access Memory) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, FPGA (Field Programmable Gate Array), ASIC (Application Specific Integrated Circuit), discrete logic, or the like. The RAM (Random Access Memory) 403 is typically used to hold variable data, stack data, executable instructions, and the like. The nonvolatile memory 404 may comprise any type of nonvolatile memory such as, but not limited to, EEPROM (Electrically Erasable Programmable Read Only Memory), flash PROM (Programmable Read Only Memory), battery backup RAM, and hard disk drives. The nonvolatile memory 404 is typically used to hold the executable firmware and any nonvolatile data. The I/O interface 405 comprises a communication interface that allows the processor 402 to communicate with devices external to the controller. Examples may comprise, but are not limited to, serial interfaces such as RS-232, USB (Universal Serial Bus), Ethernet, or SCSI (Small Computer Systems Interface). The device specific circuits 401 provide additional hardware to enable the controller 400 to perform unique functions such as, but not limited to, motor control of a cartridge gripper. The device specific circuits 401 may comprise electronics that provide, by way of example but not limitation, Pulse Width Modulation (PWM) control, Analog to Digital Conversion (ADC), Digital to Analog Conversion (DAC), etc. In addition, all or part of the device specific circuits 401 may reside outside the controller 400.

While the automated data storage library 10 is described as employing a distributed control system, the present invention may be implemented in various automated data storage libraries regardless of control configuration, such as, but not limited to, an automated data storage library having one or more library controllers that are not distributed. A library controller may comprise one or more dedicated controllers of a prior art library. For example, there may be a primary controller and a backup controller. In addition, a library controller may comprise one or more processor nodes of a distributed control system. For example, communication processor node 50 (FIG. 3) may comprise the library controller while the other processor nodes (if present) may assist the library controller and/or may provide backup or redundant functionality. In another example, communication processor node 50 and work processor node 52 may work cooperatively to comprise the library controller while the other processor nodes (if present) may assist the library controller and/or may provide backup or redundant functionality. Still further, all of the processor nodes may comprise the library controller. Herein, library controller may comprise a single processor or controller or it may comprise multiple processors or controllers.

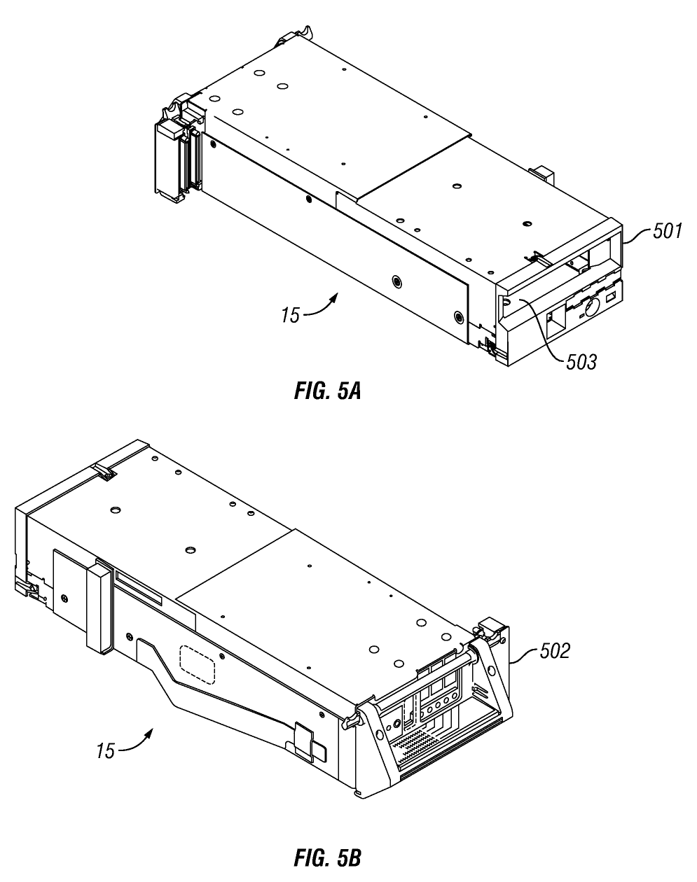

FIGS. 5A and 5B illustrate an embodiment of the front 501 and rear 502 of a data storage drive 15. In the example, the data storage drive 15 comprises a hot-swap drive canister. This is only an example and is not meant to limit the invention to hot-swap drive canisters. In fact, any configuration of data storage drive may be used whether or not it comprises a hot-swap canister. A data storage cartridge may be placed into the data storage drive 15 at opening 503. As discussed above, a data storage drive 15 is used to read and/or write data with respect to the data storage media of a data storage cartridge, and may additionally communicate with a memory which is separate from the media and is located within the cartridge.

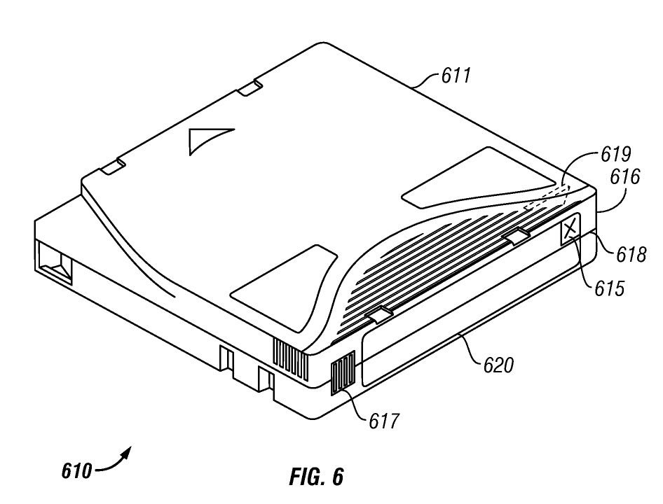

FIG. 6 illustrates various embodiments of a cartridge-like element 610 comprising an exterior shell 611 having similar external dimensions as a data storage cartridge, and examples of various fiducial marks located on the exterior shell. In one embodiment, the element 610 is a data storage cartridge, with or without any data storage media in the interior thereof. In another embodiment, the element 610 is a special purpose cartridge. In still another embodiment, the element is a solid or hollow block having similar external dimensions as a data storage cartridge. The various examples of fiducial marks comprise a mark 615 molded into the exterior shell or printed on a label affixed to the element; one or more edges 616 of the exterior shell; one or more edges or characteristics of the write protect switch area 617; the seam 618 between the two halves of the exterior shell; and one or more edges of the label well 620. As will be discussed, the fiducial mark comprises at least one contrasting edge defining a specific calibration location on the element 610.

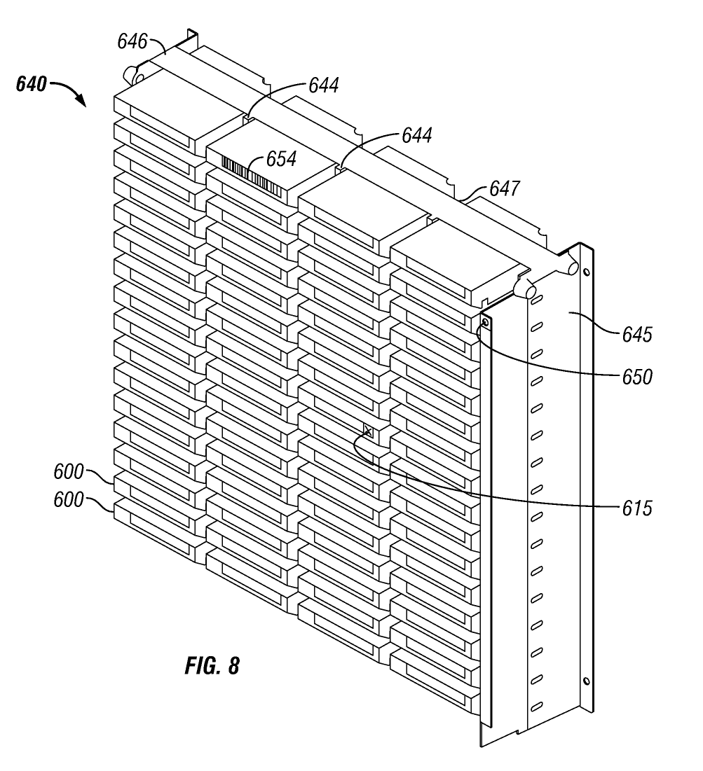

The element 610 may comprise a cartridge memory 619 shown in a partial outline portion of the Figure. The cartridge memory may be readable by the accessor or another component of the library. A cartridge label (see label 654 of FIG. 8), if any, and/or the cartridge memory 619, if any, may identify the element 610 to the library as comprising one element with the fiducial mark.

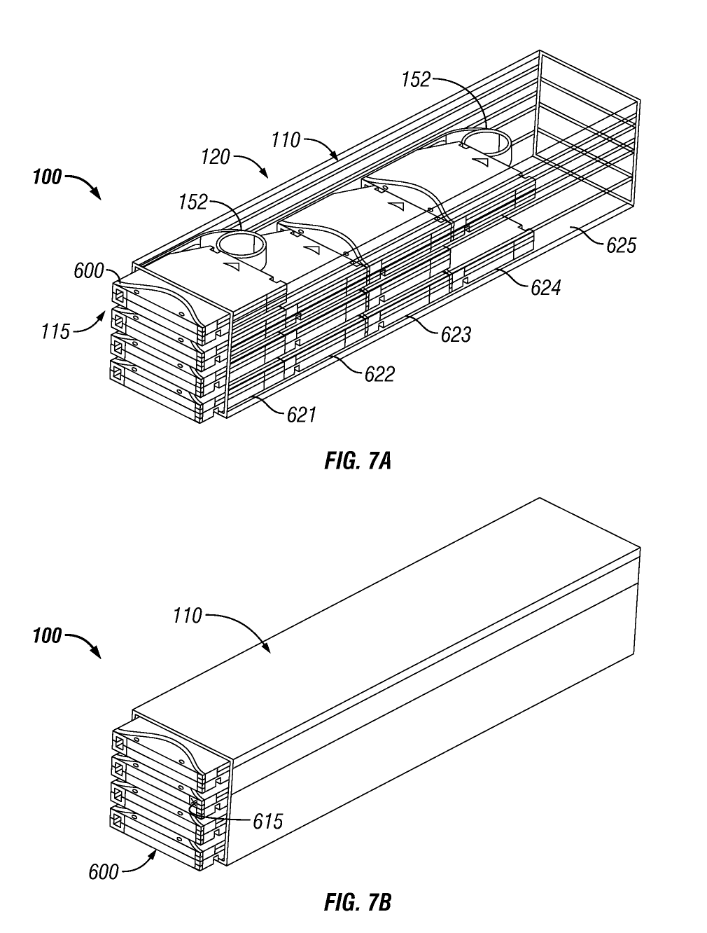

FIGS. 7A and 7B illustrate one embodiment of a multi-cartridge deep slot cell 100 that may be employed in accordance with the present invention. Multi-cartridge deep slot cell 100 comprises a housing 110 defining an interior space 115. A plurality of storage slots 120 are disposed within the housing, and are arranged in tiers from front to rear. In one embodiment, the storage slots are configured for storing up to a plurality of data storage cartridges 600 and/or elements 610.

Alternatively, the multi-cartridge deep slot cell 100 is built into the frame of the automated data storage library.

A retaining gate cartridge blocking mechanism (not shown) retains the data storage cartridges in the multi-cartridge deep slot cell 100. The retaining gate can be activated by an accessor of an automated tape library, and allows insertion of cartridges into the multi-cartridge deep slot cell. The retaining gate allows for positive cartridge retention against the pressure of biasing spring 152, and ensures that one or more data storage cartridges do not get pushed out of the front of the multi-cartridge deep slot cell 100 simultaneously while allowing the pushing mechanism of the multi-cartridge deep slot cell 100 to always push the data storage cartridge(s) to the opening in a multi-cartridge deep slot cell 100. The accessor opens the retaining gate to gain access to the data storage cartridge in the frontmost tier and, upon its extraction, the biasing spring 152 moves the cartridge(s) behind the extracted cartridge forward, promoting the cartridge(s) by one tier.

For a fuller understanding of the multi-cartridge deep slot cell and retaining gate, refer to U.S. patent application Ser. No. 11/674,904, which is entitled “Retaining Gate for Deep Storage Slot Retention of Storage Cartridges”, which is incorporated herein for reference.

Access to a storage slot may include the ability to remove a cartridge from a storage slot, the ability to place a cartridge into a storage slot, or combinations thereof.

In this example, the storage slots from top to bottom are considered to be in parallel and comprise the same tier. The storage slots from front to back, in one particular row, are considered to be in series and comprise sequential tiers.

Storage slots 120 are, in one embodiment, configured for storing up to a plurality of data storage cartridges 600, arranged in sequential order of tiers 621, 622, 623, 624 and 625 from front to rear. Herein, the frontmost tier 621 is also called “tier 1”, the next tier 622 is called “tier 2”, etc., and the last tier 625 is also called the “rearmost” tier.

Referring to FIG. 8, a bank 640 of single cartridge storage slots 644 is illustrated supported by brackets 645, 646, 647. The storage slots 644 are configured to store up to a plurality of data storage cartridges 600. The cartridges may be identified by labels 654. Mechanical tolerances typically exist within a library such that the precise positions of the storage slots and the cartridges they contain may be different from the expected positions. Calibration techniques may employ fiducial marks permanently provided at points within the library to ascertain the difference between where the fiducial is expected to be located and where it is actually located. For example, a fiducial mark 650 may be located at a corner of bracket 645 on a bank of storage slots within a library frame. This difference is then employed to adjust the expected location of one or more points within the frame or the banks of storage slots. Additional information regarding calibration of a library is provided by incorporated U.S. Patent Application Serial No. 2005/0261850, filed May 24, 2004.

The combination of deep slots, springs or biasing mechanisms, and gates of a multi-cartridge deep slot cell, or the combination of an assembly of storage slots may cause cartridges to be presented to the library accessor in unexpected ways, limiting the reliability of the calibration of a frame or bank of storage slots.

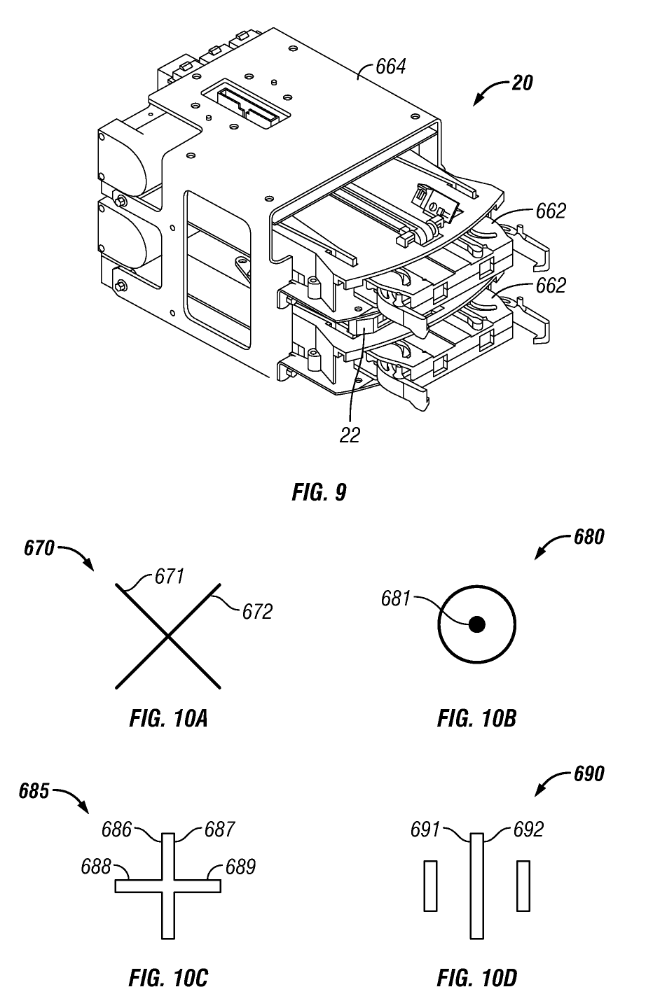

FIG. 9 depicts one embodiment of a gripper assembly 20 of FIGS. 2 and 3. The illustrated gripper assembly comprises two cartridge grippers 662 within a housing 664. Each of the cartridge grippers 662 comprises two clamping arms that are configured to grip and retain a cartridge in order to move the cartridge within the automated data storage library. Once a cartridge is moved from a source location to a target location, the clamping arms may disengage from and release the cartridge.

In one embodiment, the gripper assembly 20 comprises a calibration sensor 22 of FIG. 3 that may be used to sense or detect calibration reference points of the library, and/or to sense fiducial marks of the element (s) 610 of FIG. 6, when the element is placed in a storage slot of the library.

FIGS. 10a, 10b, 10c and 10d illustrate several alternative embodiments of fiducial marks 615 employed with the element 610 of FIG. 6. In particular, FIGS. 10a, 10b, 10c and 10d, respectively depict: a fiducial mark in the shape of an “X” 670 having contrasting edges 671, 672; a fiducial mark in the shape of concentric circles 680 having a contrasting edge 681; a fiducial mark in the shape of perpendicular bars 685 having contrasting edges 686, 687, 688, 689; and a fiducial mark in the shape of parallel bars of unequal length 690 having contrasting edges 691, 692. The contrasting edges define specific calibration locations on the element 610.

The fiducial mark comprises an energy emitting, energy absorbing and/or energy reflecting mark contrasting with the remainder of the fiducial mark to form the contrasting edge(s). Examples include magnetic marks, molded marks, imprinted or printed marks, or any other material or form capable of formation of marks having contrasting edges.

Referring to FIG. 9, the calibration sensor 22 may comprise any device or apparatus emitting energy towards the element and/or reading back energy from the fiducial mark, or detecting the fiducial mark without emitting energy towards the fiducial mark. In various examples, an emitter provides electromagnetic energy such as light, radio frequency, infrared, etc. In one embodiment, the emitter is a focused spot created from a LED. In another embodiment, the emitter is a laser. The detector provides a read back of the energy provided by the emitter. In one embodiment, the detector is a photo sensor that is capable of detecting the presence and intensity of visible or infrared light. The photo sensor may be used to find characteristics of the fiducial, such as areas of contrast, areas of various depth or distance from the emitter/detector, etc. In another embodiment, the detector is a camera, such as a CCD camera, that captures an image and logic or firmware, for example, at the controller 52, 252 of FIG. 3, to determine where the contrasting edge of the fiducial mark is located. In another embodiment, the camera is a CMOS camera. In one embodiment, the camera comprises a line scanner which, instead of capturing an image, captures one or more lines of picture elements. Alternatively, for example if the fiducial mark is a magnetic mark or has properties to affect a magnetic field, the detector comprises a Hall effect detector, an induction sensor, or other detector that may detect the presence or variations of magnetic fields.

In a further embodiment, the fiducial mark comprises at least an edge of the element, and the step of sensing the fiducial mark comprises reading the presence of the edge from reflected energy. As discussed above with respect to FIG. 6, element edges may comprise one or more edges 616 of the element or cartridge shell; one or more edges or characteristics of the write protect switch area 617; the cartridge seam 618 between the two halves of the exterior shell; and one or more edges of the label well 620, etc. The fiducial mark comprises at least one contrasting edge defining a specific calibration location on the element.

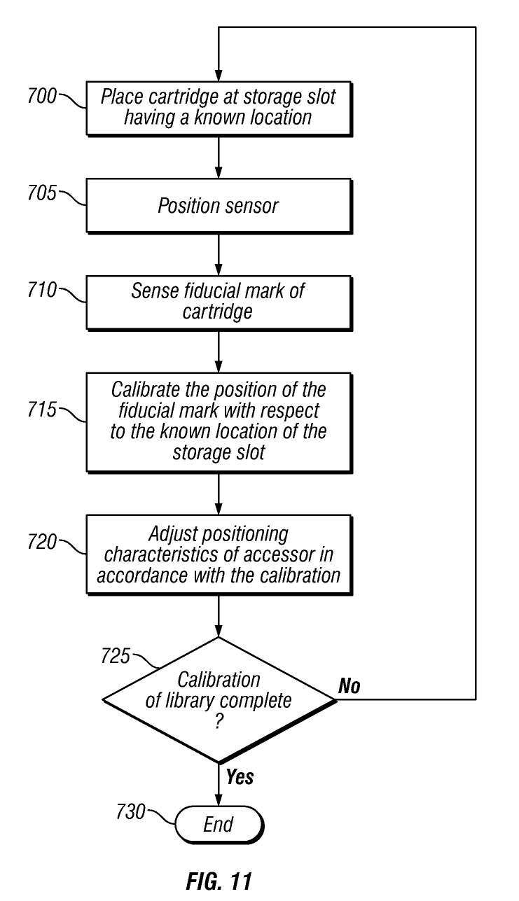

Referring to FIGS. 1-3, 6-9 and 11, in one embodiment, the controller of automated data storage library 10 operates the accessor(s) 18, 28 and their gripper assemblies 20, 30 to selectively extract, place and transport cartridges with respect to the multi-cartridge deep slot cells 100, single storage slots 16, data storage drives 15, and with respect to other elements of the automated data storage library, for example, extracting a cartridge from an input/output station 24, 25.

In step 700, the controller may extract the element 610 having similar external dimensions as a data storage cartridge and having a fiducial mark thereon from the input/output station 24, and at least one controller will direct the accessor to transport the element to a specific multi-cartridge deep slot cell 100, and place the element, for example having a fiducial mark 615, in storage slot at the frontmost tier of the specific multi-cartridge deep slot cell, the storage slot having a known location from which a calibration may be made, as shown in FIG. 7B. Alternatively, the accessor is directed to place the element 610, for example having a fiducial mark 615, in a single cartridge storage slot 644 having a known location from which a calibration may be made, as shown in FIG. 8. Still alternatively, an operator may manually place the element in the desired storage slot. Still alternatively, the element 610 may have been placed in the desired storage slot and remain in the storage slot on a permanent basis. The element 610 may comprise a standard data cartridge having standard cartridge features as fiducial marks (for example, fiducial marks 616, 617, 618, 620, etc.). Alternatively, element 610 may comprise a standard data cartridge that has been modified to include one or more fiducial marks (for example, fiducial mark 615). Still further, element 610 may comprise a special purpose cartridge that is not intended to be used for storing and retrieving customer data but it is used for calibrating cartridge storage locations in the library. Still further, the element 610 may comprise a solid or hollow block with one or more fiducial marks.

In step 705, the calibration sensor 22, 32 is positioned to sense a fiducial mark at the known location of the desired storage slot. In step 710, the sensor senses the fiducial mark of the element 610 and the precise location of the contrasting edge(s) of the fiducial mark is determined as discussed above.

In step 715, the difference between the expected position of the contrasting edge(s) at the known position of the storage slot and the sensed precise location is determined, for example, by logic or firmware, for example, at the controller 52, 252, and employed to calibrate the position of the fiducial mark with respect to the previously known location of the storage slot. In step 720, the positioning characteristics of the accessor are adjusted in accordance with the calibration. Additionally, the “known location” of the storage slot may be adjusted to conform to the newly sensed reality.

Step 725 determines whether the calibration of the library is complete, which may comprise the calibration of a number of elements 610 throughout the library, or alternatively, may comprise a single or limited number of elements at one or more specific locations. If the calibration is complete, the process ends at step 730. If the calibration is incomplete, the process returns to step 700 to place an element 610 at a storage slot having a known location, or to move the accessor to the known location at which an element 610 is located, and to repeat the process for that element.

In this manner, a reliable calibration of one or more storage slots at a specific location or throughout the automated data storage library is accomplished.

The invention can take the form of an entirely hardware embodiment, or an embodiment comprising hardware processing software elements. In a preferred embodiment, the invention is implemented in microcode of one or more controllers of FIG. 3 and employed with memory 404 and implemented by processor 402 of FIG. 4.

Furthermore, the invention can take the form of a computer program product accessible from a computer usable or computer readable storage medium providing program code for use by or in connection with one or more controllers. For the purposes of this description, a computer usable or computer readable storage medium can be any apparatus that can contain, store, communicate, propagate, or transport the program for use by or in connection with the instruction execution system, apparatus, or device.

The storage medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, and random access memory (RAM), a read-only memory (ROM), a rigid magnetic disk and an optical disk. Current examples of optical disks include compact disk-read only memory (CD-ROM), compact disk-read/write (CD-R/W) and DVD.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A method for calibrating an automated data storage library having a plurality of storage slots configured to store at least one data storage cartridge, comprising the steps of:
placing an element having similar external dimensions as a data storage cartridge in one of said plurality of storage slots having a known location, said element having a fiducial mark thereon;
sensing said fiducial mark; and
calibrating the position of said fiducial mark with respect to said known location of said storage slot.

2. The method of claim 1, wherein said step of sensing said fiducial mark comprises emitting energy towards said element and reading back energy from said fiducial mark.

3. The method of claim 2, wherein said fiducial mark comprises at least an edge of said element, and said step of sensing said fiducial mark comprises reading the presence of said edge from reflected said energy.

4. The method of claim 1, wherein said fiducial mark comprises an energy emitting material, and said step of sensing said fiducial mark comprises reading said energy from said fiducial mark.

5. The method of claim 1, wherein said automated data storage library comprises at least one accessor configured to selectively extract, place and transport said data storage cartridges with respect to said storage slots; and wherein said placing step and said sensing step are conducted by at least one said accessor.

6. The method of claim 1, wherein said plurality of storage slots comprise at least one from the set of single cartridge storage slots, slots of multi-cartridge deep slot cells arranged in tiers from front to rear, I/O station slots, and data storage drive slots; and said step of placing said element comprises placing said element in one of: said single cartridge storage slots; the frontmost tier of one of said multi-cartridge deep slot cells; an I/O station slot; and a data storage drive slot.

7. An automated data storage library, comprising:
a plurality of storage slots configured to store at least one data storage cartridge;
at least one accessor configured to selectively extract, place and transport said data storage cartridges with respect to said storage slots, and comprising a sensor; and
at least one controller configured to:
operate said at least one accessor to position said sensor to sense an element at one of said plurality of storage slots having a known location, said element having similar external dimensions as a data storage cartridge and having a fiducial mark thereon;
operate said sensor to sense said fiducial mark; and
calibrate the position of said fiducial mark with respect to said known location of said storage slot.

8. The automated data storage library of claim 7, wherein said at least one controller additionally operates said at least one accessor to place said element having similar external dimensions as a data storage cartridge in said storage slot having a known location.

9. The automated data storage library of claim 8, wherein said plurality of storage slots is comprised of at least one from the set of: single cartridge storage slots, slots of multi-cartridge deep slot cells arranged in tiers from front to rear, I/O station slots, and data storage drive slots; and said at least one controller is configured to, in said step of operating said at least one accessor to place said element, to place said element in one of: said single cartridge storage slots; the frontmost tier of one of said multi-cartridge deep slot cells; an I/O station slot; and a data storage drive slot.

10. The automated data storage library of claim 7, wherein said sensor comprises a camera.

11. The automated data storage library of claim 7, wherein said sensor comprises a Hall effect detector.

12. The automated data storage library of claim 7, wherein said sensor comprises an emitter configured to emit energy towards said cartridge and a detector configured to read back energy from said fiducial mark.

13. An accessor system of an automated data storage library, said automated data storage library having a plurality of storage slots configured to store at least one data storage cartridge, comprising:
accessor apparatus configured to selectively extract, place and transport said data storage cartridges;
a sensor; and
at least one controller configured to:
operate said accessor apparatus to place said sensor in a position to sense an element at one of said plurality of storage slots having a known location, said element having similar external dimensions as a data storage cartridge and having a fiducial mark thereon;
operate said sensor to sense said fiducial mark; and
calibrate the position of said fiducial mark with respect to said known location of said storage slot.

14. The accessor system of claim 13, wherein said at least one controller additionally operates said accessor apparatus to place said element having similar external dimensions as a data storage cartridge in said storage slot having a known location.

15. The accessor system of claim 14, wherein said plurality of storage slots of said automated data storage library is comprised of at least one from the set of single cartridge storage slots, slots of multi-cartridge deep slot cells arranged in tiers from front to rear, I/O station slots, and data storage drive slots; and said at least one controller is configured to operate said accessor apparatus, in said step of placing said element, to place said element in one of: said single cartridge storage slots; the frontmost tier of one of said multi-cartridge deep slot cells; an I/O station slot; and a data storage drive slot.

16. The accessor system of claim 13, wherein said sensor comprises a camera.

17. The accessor system of claim 13, wherein said sensor comprises a Hall effect detector.

18. The accessor system of claim 13, wherein said sensor comprises an emitter configured to emit energy towards said element and a detector configured to read back energy from said fiducial mark.

19. An element, comprising:
an exterior shell having similar external dimensions as a data storage cartridge; and
a fiducial mark located on said exterior shell comprising at least one contrasting edge defining a specific calibration location on said element.

20. The element of claim 19, wherein said fiducial mark comprises at least one of: an energy emitting mark, an energy absorbing mark, and an energy reflecting mark; said mark contrasting with the remainder of said fiducial mark to form said at least one contrasting edge.

21. The element of claim 19, wherein said fiducial mark comprises at least one of:
one or more edges of the element shell, one or more edges of a write protect switch, the seam between two halves of an exterior shell, one or more edges of a label well, a calibration label, a special purpose calibration mark.
